(19) United States
(12) Patent Application Publication
(10) Pub. No.: US 2016/0209527 A1
(43) Pub. Date: Jul. 21, 2016

(54) APPARATUS FOR PHOTOGRAPHING RADIOACTIVE SUBSTANCE BY USING SMART DEVICE

(71) Applicant: Young Chan WOO, Busan (KR)

(72) Inventor: Young Chan WOO, Busan (KR)

(21) Appl. No.: 15/024,390

(22) PCT Filed: Sep. 25, 2014
(86) PCT No.: PCT/KR2014/008961

§ 371 Date: Mar. 24, 2016

(30) Foreign Application Priority Data
Sep. 26, 2013 (KR) 10-2013-0114603
Feb. 5, 2014 (KR) 10-2014-0012887

(51) Int. Cl. G01T 7/00; H04N 5/225

(52) U.S. Cl. CPC G01T 7/00; H04N 5/2257; H04N 5/2254

(57) ABSTRACT

Disclosed is an apparatus for photographing a radioactive substance by using a smart device, the apparatus including: a radioactive information collection unit including a camera barrel, a dark curtain as a visible light blocking filter provided at an object-side extremity of the camera barrel, and an intensifying layer being sensitive to radioactive rays and generating visible light by being provided on a rear surface of the dark curtain; a smart device; a mount coupled to the radioactive information collection unit by being mounted at an eye-side extremity of the camera barrel such that an optical axis of a camera lens of the smart device matches up with an optical axis of the camera barrel; and an application provided in the smart device for calculational processing and output of image information produced via the radioactive information collection unit.

### TECHNICAL FIELD

The present invention relates to an apparatus for photographing a radioactive substance by using a smart device, the apparatus including: a radioactive information collection unit including a camera barrel, a dark curtain as a visible light blocking filter provided at an object-side extremity of the camera barrel, and an intensifying layer being sensitive to radioactive rays and generating visible light by being provided on a rear surface of the dark curtain; a smart device; a mount coupled to the radioactive information collection unit by being mounted at an eye-side extremity of the camera barrel such that an optical axis of a camera lens of the smart device matches up with an optical axis of the camera barrel; and an application provided in the smart device for calculational processing and output of image information produced via the radioactive information collection unit, wherein the apparatus is capable of outputting a radioactive substance included in a subject, as a radioactive picture, an image, or text by using the smart device.

### BACKGROUND ART

Fukushima nuclear power plant accident caused by a huge earthquake on 11 Mar. 2011 has emerged as a serious problem threatening the entire northern hemisphere marine ecosystem in addition to Japan.

Nevertheless, people in general cannot obtain accurate information on radiation, so they rely on the government's announcements. For this reason, groundless rumors have spread, and the fish market has been disturbed by fear of food contamination.

Consequently, interest in radiation dosimetry is growing among people in general. However, there is no radioactivity detector easily available to the general public.

To detect gamma rays that are a major source of radioactive contamination, the following are widely used: a GM tube, an ionization chamber, a Nal (Ti) scintillation detector, a germanium semiconductor detector, and a radiophotoluminescence dosimeter.

Among radiation dosimeters using principles described above, as a portable device with a satisfactory price and size, the following methods are widely used: a scintillation survey meter for measuring an outer spatial dose of a radioactive contaminated substance, and a Geiger counter for measuring surface contamination, wherein the Geiger counter is a counter for counting the number of gamma rays that enter a GM tube.

These conventional devices for measuring the radioactive contaminated substance are problematic in that it is difficult to use the devices without specific technical knowledge. Further, such conventional devices are problematic in that people in general have difficulties in interpreting the measurements and in understanding information correctly.

Meanwhile, for X-rays that are included in the range of radiation, a medical X-ray imaging device is widely known. Such X-ray imaging devices are available in both large and small sizes, and the small size X-ray imaging device is frequently used in the dental field.

As documents of related art relating to a medical X-ray imaging device, there are Korean Patent No. 10-0859042, Korean Patent Application No. 10-2007-0110545, Korean Utility Model No. 20-0358826, etc.

The documents of the related art disclose devices that sense rated X-rays within a room and obtain image information for medical use. However, the conventional devices are not used to detect radioactive contamination. In particular, the conventional devices have not been developed into a portable device.

Meanwhile, radioactive rays that are radiated by radioactive contaminated substances include alpha rays as well as beta rays and gamma rays. The conventional radioactivity detector has focused on technologies for detecting gamma rays.

Recently, as another document of related art depending on versatility of smart phone, Japanese Patent Application Publication No. 2012-233892 discloses a technology of combining a device for measuring a radioactive contaminated substance with a smart phone. However, this technology is about combining a dosimeter for measuring the dose of a radioactive contaminated substance with a smart phone. Thus, this technology has nothing to do with an X-ray imaging device for a radioactive contaminated substance.

### DISCLOSURE

### Technical Problem

Accordingly, the present invention has been made keeping in mind the above problems occurring in the related art, and the present invention is intended to propose an apparatus for photographing a radioactive substance by using a smart device, the apparatus being capable of allowing information on radiation to be easily detected by photographing a radioactive substance in a manner similar to an X-ray picture using a smart device that people generally carry, and being capable of forming a radioactive information cloud through interpreting, outputting, and sharing the volume of collected information.

### Technical Solution

In order to achieve the above object, according to one aspect of the present invention, there is provided an apparatus for photographing a radioactive substance by using a smart device including: a radioactive information collection unit including a camera barrel, a dark curtain as a visible light blocking filter provided at an object-side extremity of the camera barrel, and an intensifying layer being sensitive to radioactive rays and generating visible light by being provided on a rear surface of the dark curtain; a smart device; a mount coupled to the radioactive information collection unit by being mounted at an eye-side extremity of the camera barrel such that an optical axis of a camera lens of the smart device matches up with an optical axis of the camera barrel; and an application provided in the smart device for calculational processing and output of image information produced via the radioactive information collection unit, wherein the apparatus is capable of outputting a radioactive substance included in a subject, as a radioactive picture, an image or text by using the smart device.

Herein, in the apparatus for photographing a radioactive substance by using a smart device, the radioactive information collection unit may be provided with an image intensifier tube on a rear surface of the intensifying layer for amplifying a photoreaction of the intensifying layer, thereby amplifying reactive visible light.

In the apparatus for photographing a radioactive substance by using a smart device, the radioactive information collection unit may further include a light collector provided on the rear surface of the intensifying layer.

Further, in the apparatus for photographing a radioactive substance by using a smart device, the intensifying layer may be provided in the form of an intensifying screen that causes a visible light reaction to radioactivity.

Further, in the apparatus for photographing a radioactive substance by using a smart device, the camera barrel may be configured such that: an end thereof is bent to be reverse L-shaped; a communicating hole for visible light is provided at a lower portion of the end being bent, the communicating hole corresponding to an optical axis of a camera of the smart device; and a prism provided at the end being bent matches up an optical axis of an image coming into the communicating hole for visible light with an optical axis of an output image of the radioactive information collection unit, combines the image coming into the communicating hole and the output image of the radioactive information collection unit together, and sends the combined image to the camera of the smart device, whereby the apparatus is capable of outputting an image of the camera of the smart device, along with information on radiation.

Further, in the apparatus for photographing a radioactive substance by using a smart device, the mount may include: a battery casing having a battery for supplying power to the image intensifier tube; and a connecting terminal for inputting/outputting a command signal for controlling the battery by being connected to the smart device.

Further, in the apparatus for photographing a radioactive substance by using a smart device, the mount may be provided in the form of a smart device casing so as to serve as a camera for photographing a radioactive substance when being mounted to the smart device.

Further, in order to achieve the above object, according to another aspect of the present invention, there is provided an apparatus for photographing a radioactive substance by using a smart device, the apparatus including: a camera unit configured such that a light collector, an image intensifier tube and an image pickup device are sequentially coupled to a camera barrel, and a radioactive information collection unit including a dark curtain and an intensifying layer is coupled to a front end or a rear end of the light collector so that the radioactive information collection unit blocks visible light, and generates visible light by being sensitive to radioactive rays, thereby outputting radioactive image information; a smart device; a wire or wireless interface for interfacing the camera unit with the smart device; and an application provided in the smart device for calculational processing and output of image information produced via the radioactive information collection unit, wherein the apparatus is capable of outputting a radioactive substance included in a subject, as a radioactive picture, an image or text by using the smart device.

The apparatus for photographing a radioactive substance by using a smart device may further include a mount for coupling the camera unit and the smart device such that an optical axis of the camera unit matches up with an optical axis of a camera lens of the smart device.

Further, in the apparatus for photographing a radioactive substance by using a smart device, the application may include content for controlling camera shutter speed used to photograph optical information on radiation.

### Advantageous Effects

According to the present invention having the above-described characteristics, it is possible to allow information on radiation to be easily detected by photographing a radioactive substance in a manner similar to an X-ray picture by using a smart device that people generally carry, and possible to form a radioactive information cloud through interpreting, outputting, and sharing the volume of collected information.

### DESCRIPTION OF DRAWINGS

FIG. 1 is an exemplary perspective view showing application of the present invention to a smart device;

FIG. 2 is an exemplary perspective view showing application of the present invention to a camera;

FIG. 3 is a rear surface perspective view showing the smart device to which the present invention is applied;

FIG. 4 is an inside diagram showing a smart device casing to which the present invention is applied;

FIG. 5 is a side sectional view showing a radioactive information collection unit according to the present invention;

FIG. 6 is a side sectional view showing the radioactive information collection unit including an image intensifier tube according to the present invention;

FIG. 7 is a side sectional view showing the radioactive information collection unit including an optical fiber lens and the image intensifier tube;

FIG. 8 is a side sectional view showing the radioactive information collection unit including an optical lens and the image intensifier tube;

FIG. 9 is an exemplary view showing a network of the present invention;

FIG. 10 is a side sectional view showing the radioactive information collection unit including a prism;

FIG. 11 is a side sectional view showing a camera unit according to the present invention; and

FIG. 12 is a perspective view showing combination of the camera unit and the smart device.

### DESCRIPTION OF REFERENCE CHARACTERS OF IMPORTANT PARTS

| 10: smart device | 20: mount |
|---|---|
| 30: radioactive information collection unit | |
| 30-1: camera unit | 40: prism |
| 50: communicating hole for visible light | |
| 100: lens | 300: camera barrel |
| 310: dark curtain | 320: intensifying layer |
| 330: light collector | |
| 340: image intensifier tube | |
| 360: image pickup device | 400: battery |

500: server

### BEST MODE

Reference will now be made in greater detail to an exemplary embodiment of the present invention, an example of which is illustrated in the accompanying drawings. In the following description of the present invention, detailed descriptions of known functions and components incorporated herein will be omitted when it may make the subject matter of the present invention unclear.

Terms used in the description of the present invention may be defined in the context of the function of the present invention. Since the terms may vary depending on the practice or intention of those skilled in the art, the definitions thereof may be based on the entire specification.

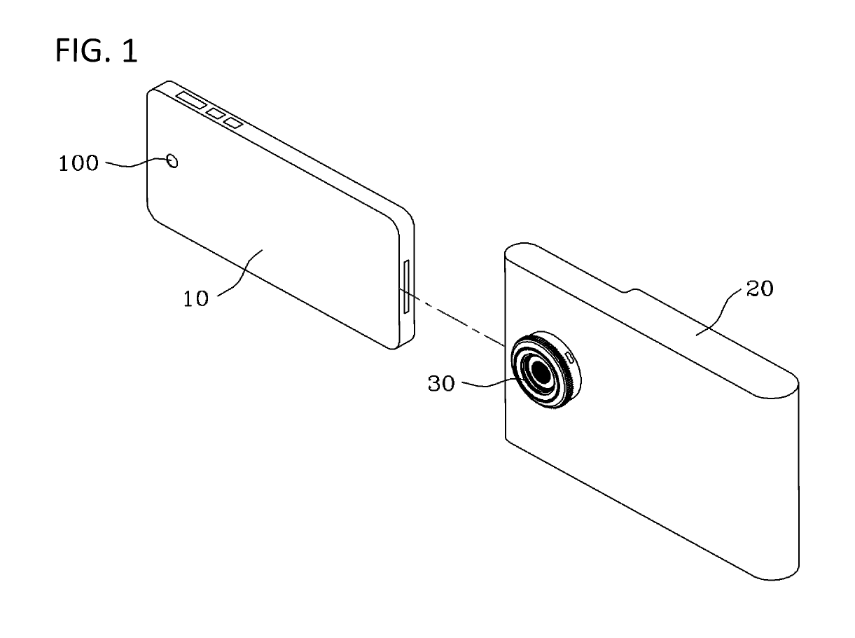

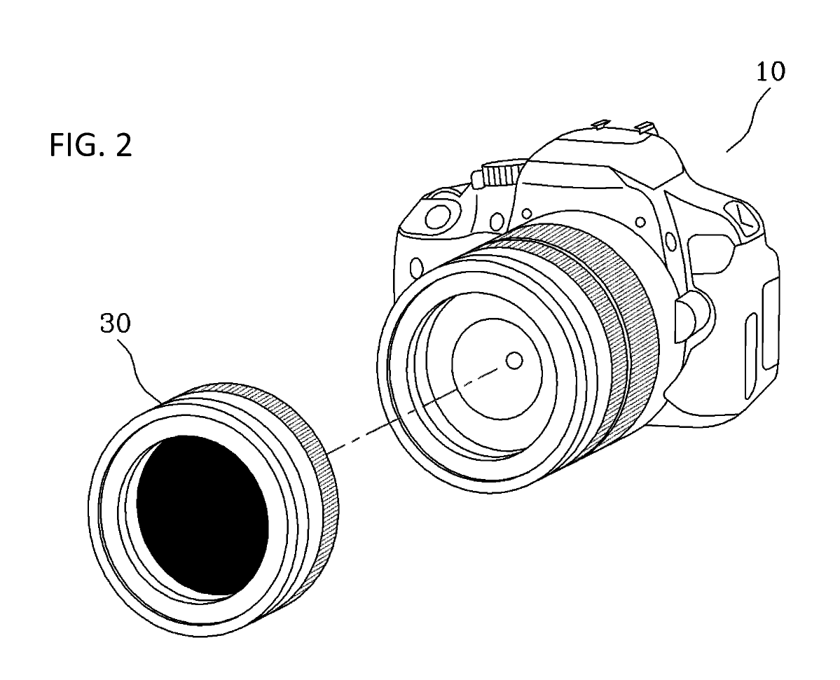

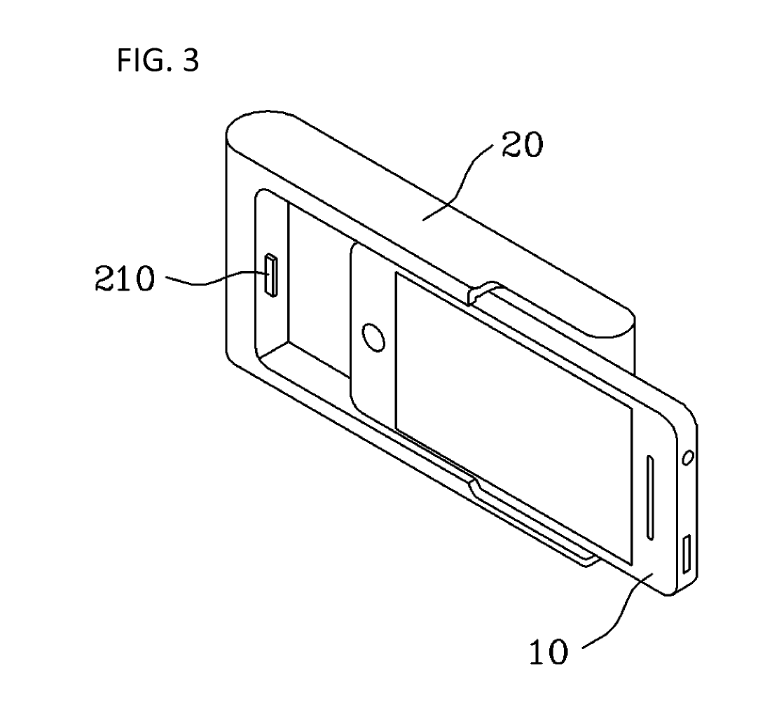

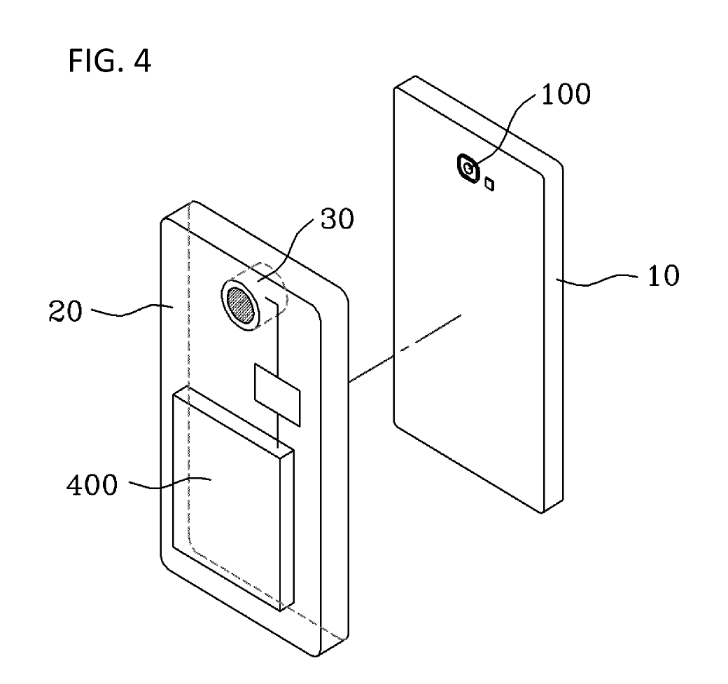

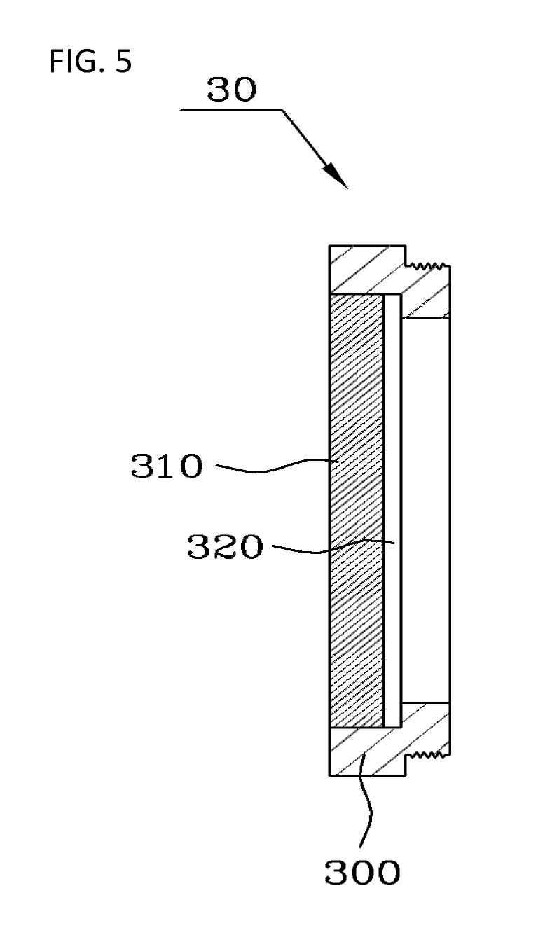

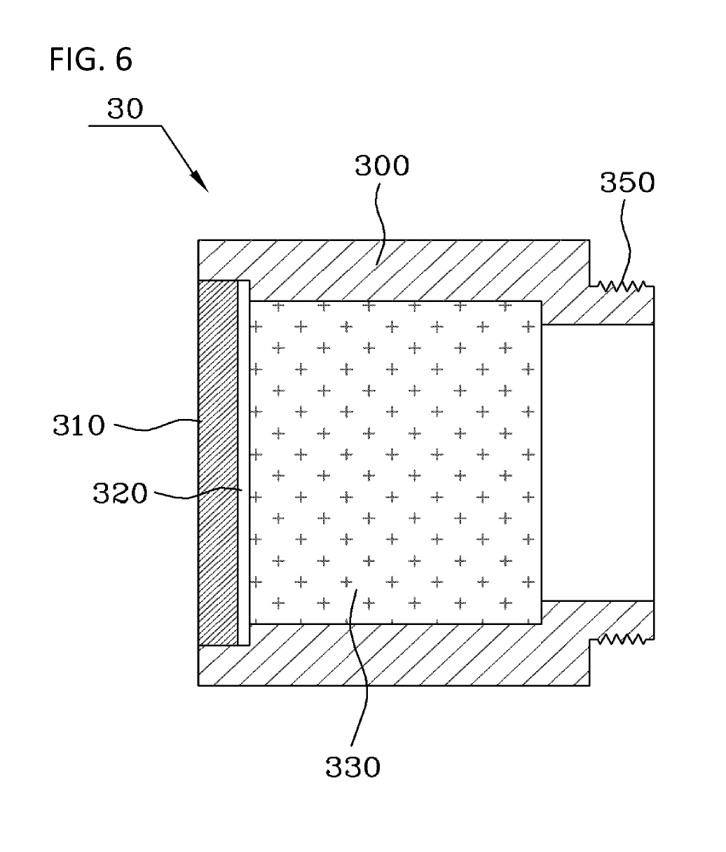

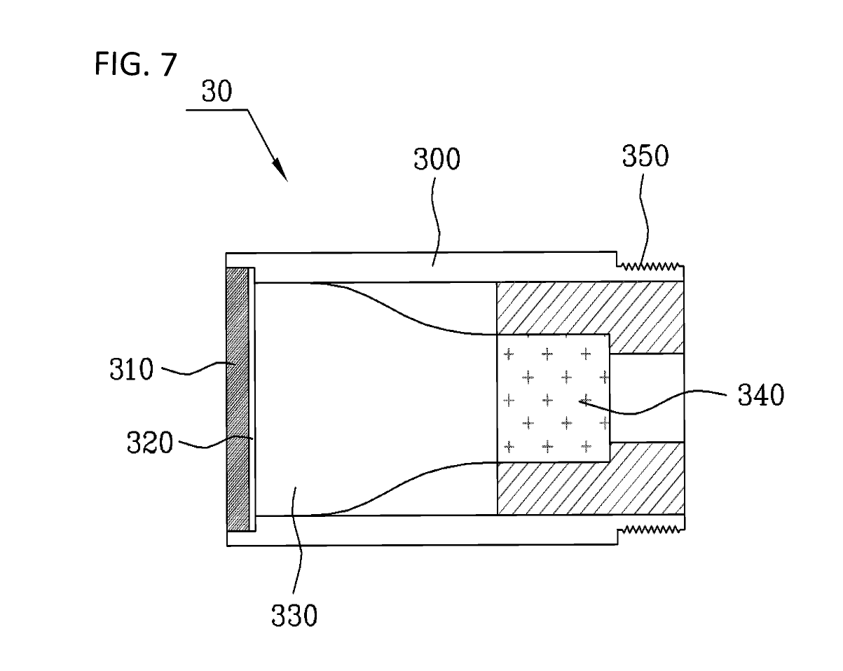

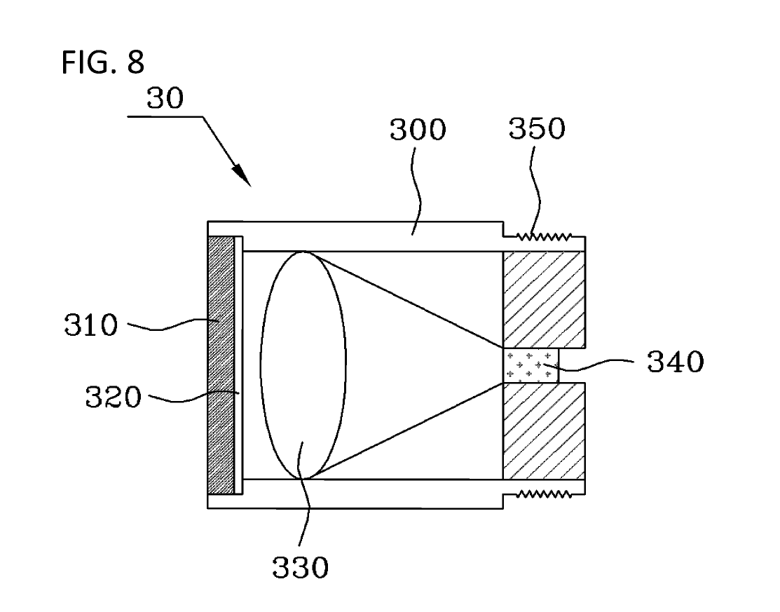

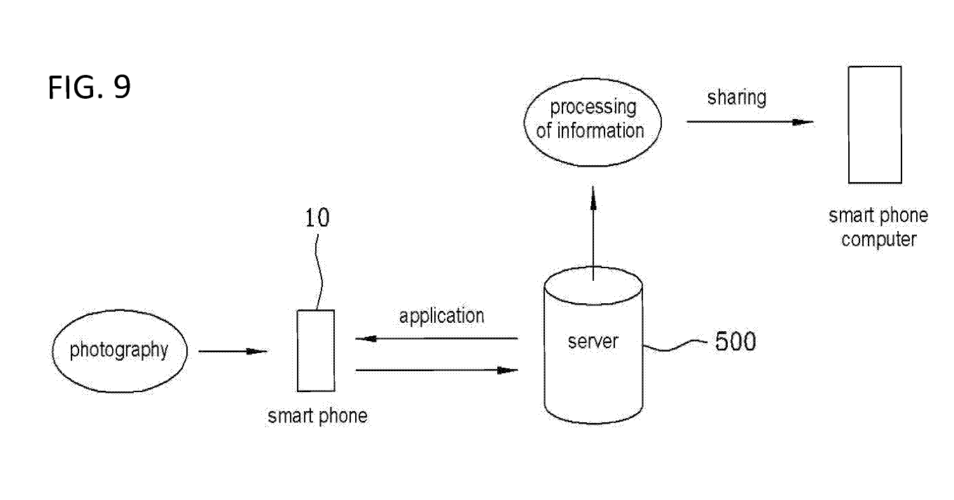

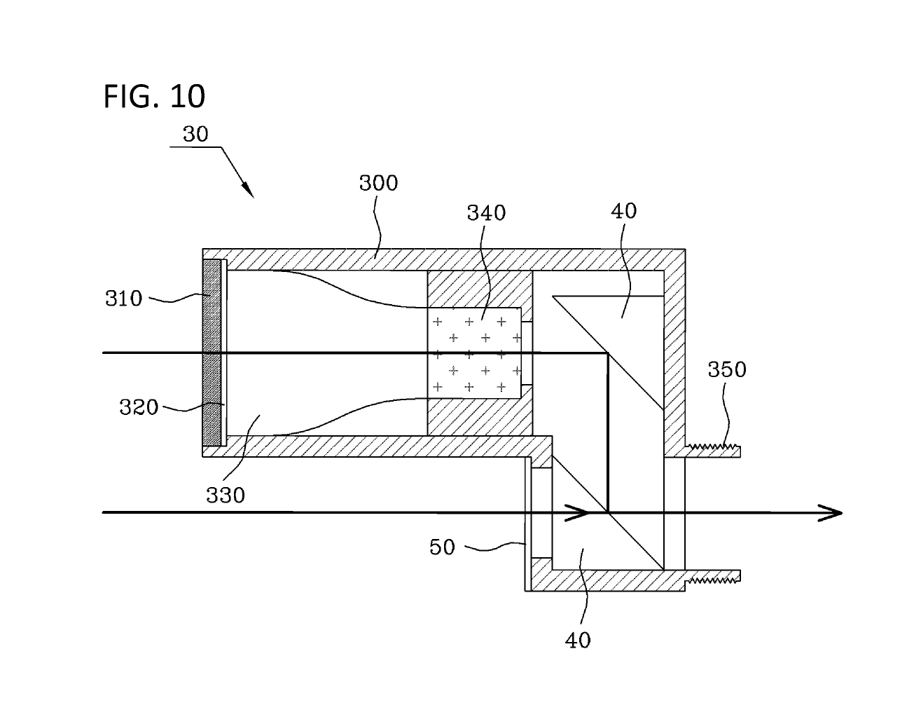

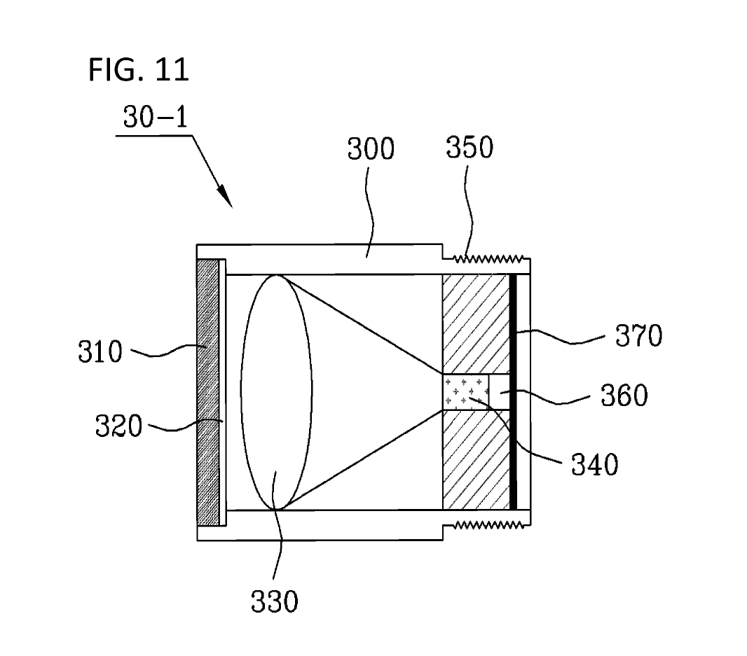

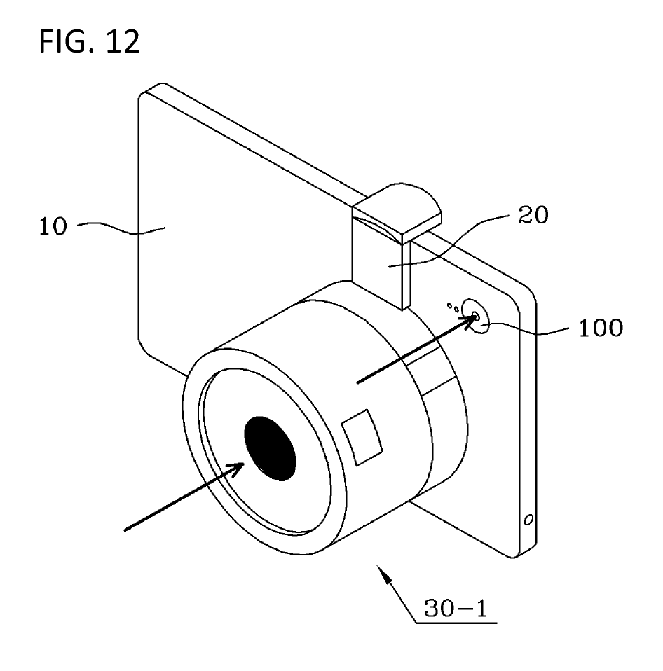

FIG. 1 is an exemplary perspective view showing application of the present invention to a smart device; FIG. 2 is an exemplary perspective view showing application of the present invention to a camera; FIG. 3 is a rear surface perspective view showing the smart device to which the present invention is applied; FIG. 4 is an inside diagram showing a smart device casing to which the present invention is applied; FIG. 5 is a side sectional view showing a radioactive information collection unit according to the present invention; FIG. 6 is a side sectional view showing the radioactive information collection unit including an image intensifier tube according to the present invention; FIG. 7 is a side sectional view showing the radioactive information collection unit including an optical fiber lens and the image intensifier tube; FIG. 8 is a side sectional view showing the radioactive information collection unit including an optical lens and the image intensifier tube; FIG. 9 is an exemplary view showing a network of the present invention; FIG. 10 is a side sectional view showing the radioactive information collection unit including a prism; FIG. 11 is a side sectional view showing a camera unit according to the present invention; and FIG. 12 is a perspective view showing combination of the camera unit and the smart device.

As shown in the accompanying drawings, the present invention discloses an apparatus for obtaining a degree of radioactive contamination of a subject as image information, wherein the apparatus includes: a smart device 10; a mount 20; a camera lens 100; a camera barrel 300; a dark curtain 310; an intensifying layer 320; a light collector 330; an image intensifier tube 340; a radioactive information collection unit 30; and an application (not shown).

As shown in the accompanying drawings, the present invention discloses an apparatus for photographing a radioactive contaminated subject using the smart device 10.

The smart device 10 refers to a portable device, such as smart camera, smart phone, smart pad, etc., that is capable of accessing an external network. However, the present invention is not limited to the portable device, but applicable to a camera by being applied to a camera lens.

As shown in FIG. 1, the present invention uses a camera lens 100 of the smart device 10; and as shown in FIG. 12, the present invention may have a camera unit 30-1 for directly outputting image information. Firstly, reference will be made to a method of using the camera lens 100 of the smart device 10.

The smart device 10 refers to a portable information processing device, such as a smart phone, a smart pad or a smart camera, that has a camera lens for allowing image output.

The present invention discloses an apparatus for identifying a degree of radioactive contamination of a subject through image output of the smart device 10 by combining the smart device 10 with the radioactive information collection unit 30 that outputs image information by converting information on radiation that a radioactive substance radiates, into visible light.

In the method of using the camera lens 100 of the smart device 10, the smart device 10 is provided with the mount 20 for mounting the radioactive information collection unit 30 in such a way that an optical axis of a camera lens 100 of the smart device 10 matches up with an optical axis of the radioactive information collection unit 30.

In a method of using a camera, as shown in FIG. 2, in the case that the mount 20 is configured to be mounted to a filter mount of the camera lens, the mount 20 may be mounted to a camera in a similar manner as a filter.

A shape of the mount 20 may be in variable shapes, such as a frame shown in FIG. 12. Preferably, as shown in FIG. 1, the mount 20 may be configured to be a smart device casing having a connecting terminal 210 for connecting the smart device and information such that the smart device serves as a camera for photographing radioactive rays.

As shown in FIG. 5, the radioactive information collection unit 30 may include: a camera barrel 300 serving as a casing of the radioactive information collection unit 30; a dark curtain 310; and an intensifying layer 320, whereby the radioactive information collection unit 30 may be configured in a manner similar to camera filter.

As described above, the camera barrel 300 is coupled to the mount 20 in such a way that an optical axis of the camera lens 100 of the smart device 10. To achieve this, the camera barrel 300 may include a mount coupling means 350 similar to a camera filter.

The dark curtain 310, as a visible light blocking filter, is provided at an object-side extremity of the camera barrel 300, for preventing visible light from entering the camera lens 100 of the smart device 10.

The intensifying layer 320 is provided on a rear surface of the dark curtain 310 of the camera barrel 300, and the intensifying layer 320 is a photoreaction part, which generates visible light by being sensitive to radioactive rays that pass through the dark curtain 310.

In general, the intensifying layer 320 is mostly in the form of an intensifying screen for medical use, such as an X-ray detector, wherein the intensifying screen is a material that causes a photoreaction to alpha rays, beta rays, gamma rays, as well as X-rays.

Thus, for a radioactive contaminated subject, the intensifying screen is sensitive to all kinds of radioactive rays that the subject radiates, thereby outputting visible light.

In the present invention, the intensifying layer 320 may be coated on a rear surface of the dark curtain 310. Preferably, the intensifying layer 320 is provided in the form of the intensifying screen, thereby facilitating replacement thereof.

In the present invention, even if an existing medical X-ray intensifying screen is used as the intensifying screen, a photoreaction to radioactivity can sufficiently occur. That is because most of radioactive contamination is caused by cesium.

In other words, cesium is used as a major radioactive light source of the X-ray imaging device, so the intensifying screen is configured to be most sensitive to cesium in photoreaction. This feature allows a radioactive contaminated subject to be photographed.

According to above described configuration, when taking a picture of a subject with the smart device 10, an object without radioactive contamination may be photographed dark because visible light is blocked by the dark curtain 310; on the contrary, a radioactive contaminated subject may be photographed as image information in a manner similar to an X-ray picture because radioactive rays passing through the dark curtain 310 react to the intensifying layer 320, thereby generating light.

However, the photoreaction of the intensifying layer 320 may be too weak to be recognized by eye, and photographic sensitivity may vary depending on a degree of radioactive contamination of a subject. Thus, in order to obtain more information on radiation from a subject, the radioactive information collection unit 30 may be configured such that a wider aperture may be provided thereon; a photoreaction image may be intensified; and a shutter speed of a camera may be made slower.

To achieve this, as shown in FIG. 6, the present invention may be configured such that in order to intensify the photoreaction image, an image intensifier tube 340 is provided on a rear surface of the intensifying layer 310.

The image intensifier tube 340 is a device that converts entering photons into electrons in an optical-cathode tube, amplifies the electrons with a micro channel plate, and releases the electrons from a fluorescent screen. The image intensifier tube 340 is mainly used for X-ray detectors or military night vision goggles.

The light collector 330 is configured such that an object-side of the radioactive information collection unit 30 according to the present invention is provided with a wider aperture so as to collect more radioactive rays of a subject, wherein the light collector 330 may be in the form of an optical lens as shown in FIG. 8, or an optical fiber lens as shown in FIG. 7.

The present invention may be configured such that the radioactive information collection unit 30 includes only the light collector 330 without the image intensifier tube 340 that is shown in FIGS. 7 and 8, thereby obtaining and amplifying image information, and then outputting the image information to the application of the smart device 10.

Preferably, in order to increase radioactivity detection sensitivity, as shown in FIGS. 7 and 8, the light collector 330 may be provided with the image intensifier tube 340 that amplifies light and outputs the light.

Further, the image intensifier tube 340 is a factor in raising manufacturing cost because unit cost thereof increases considerably in proportion to a size thereof. When the light collector 330 is used to collect light, a small image intensifier tube 340 may be used. Thus, the present invention is advantageous in that it is possible to reduce manufacturing cost considerably.

Further, the present invention is advantageous in that it is possible to increase sensitivity with a camera lens aperture for smart device that uses a small lens.

Meanwhile, the present invention may be configured to provide a camera unit 30-1 that performs a camera function, as shown in FIG. 12, instead of using the camera lens 100 of the smart device 10.

As shown in FIG. 11, the camera unit 30-1 may be configured such that a light collector 330, an image intensifier tube 340 and an image pickup device 360, such as CCD (charge couple device), are sequentially coupled to a camera barrel 300; and a photoreaction part is provided at a front end or a rear end of the light collector 330 by providing a dark curtain 310 and an intensifying layer 320.

In other words, the camera unit 30-1 is a separate camera, which is formed by adding an imaging device to a radioactive information collection unit 30, wherein the camera unit 30-1 may mean a lens camera for outputting a radioactive image.

Thus, the light collector 330 functions as an objective lens of a camera.

In the camera unit 30-1, when there is a need to make the image intensifier tube 340 small, an additional light collector for collecting light may be added between the image intensifier tube 340 and the image pickup device 360.

In the camera unit 30-1 configured as described above, radioactive image information is produced by being sensitive to radioactive rays while blocking visible light.

In the present invention, as the camera unit 30-1 produces a separate photographed image apart from a smart device, a wire or wireless interface may be provided so as to send the radioactive image information to the smart device 10 by interfacing the camera unit 30-1 with the smart device 10.

In the smart device 10 configured as described above, an application may be installed thereon for calculational processing of radioactive image information, and outputting the information, as a radioactive picture, an image, or text information.

The application is software that interprets radioactive image information input into the smart device 10, outputs the image information on a smart phone screen, and provides additional digitized text or image information so as to allow the information to be easily recognized.

According to the present invention, when photographing a radioactive contaminated substance, an image of a contaminated part of the subject is photographed with a smart device in a manner similar to an X-ray picture.

The smart device 10 according to the present invention configured as described above may include the application that processes and calculates input information and outputs the information. Herein, the application (not shown) may be downloaded from a server 500 so as to interpret and output the image information.

In other words, in the smart device 10, an image or a picture of a subject that is input into the application is output as it is. When a volume of light is insufficient, the application transforms the image into an optimum image by amplifying or processing the image so as to allow a user to recognize a degree of radioactive contamination with his/her eye, and interprets volume of light and a light distribution of a picture, thereby outputting a degree of radioactive contamination of a subject by digitizing and texting the interpreted result.

Further, the application may include content that controls camera shutter speed used to optimally photograph optical information on radiation so as to increase radioactivity detection sensitivity of a smart phone

Thus, as occasion demands, the application may provide a function to guide for allowing a micro-contaminated subject to be photographed by making exposure time long, using a tripod for supporting a smart device.

According to the present invention configured as described above, there is provided an apparatus for photographing a radioactive substance by using a smart device, the apparatus capable of allowing a radioactive substance included in a subject to be produced as a radioactive picture or an image by using the smart device.

Meanwhile, in a radioactive image according to the present invention, visible light is blocked. Thus, in a case of a subject that is partially contaminated, even though a photoreaction to radioactivity is partially displayed on a dark screen, it may be difficult to know which part of the subject is contaminated.

In other words, in a case of living matter, the radioactive image may be displayed in a manner similar to an X-ray picture because contamination spreads all over living matter. However, in a case of non-living matter, which is contaminated on surface thereof, an image of a partial photoreaction to radioactivity is produced, whereby it may be difficult to know which part of a subject a photoreaction actually occurs on.

To solve this problem, the present invention is configured such that a visible light image and an image of a photoreaction to radioactivity are combined together, and the combined image is output to the smart device 10, thereby allowing information on radiation to be recognized, directly from the image of a subject.

To achieve this, as shown in FIG. 10, the present invention may be configured such that an end of the camera barrel 300 is bent to be reverse L-shaped; a communicating hole for visible light 50 is provided at a lower portion of the bent end of the camera barrel 300, the communicating hole 50 corresponding to an optical axis of a camera of the smart device 10; and a prism 40 provided at the end being bent matches up an optical axis of an image coming into the communicating hole for visible light 50 with an optical axis of an output image of the radioactive information collection unit 30, combines the image coming into the communicating hole 50 and the output image of the radioactive information collection unit 30 together, and sends the combined image to the camera of the smart device 10.

In other words, the present invention may be configured such that image information on radioactivity and image information on visible light are simultaneously photographed through a parallel optical axis by using the prism 40, whereby a visible light image is combined with a radioactive image, and then the combined image is output to the smart device 10.

In a case of using the camera unit 30-1, as shown in FIG. 12, the camera lens 100 of the smart device 10, and the camera unit 30-1 are capable of photographing separately. Thus, simultaneously photographed images or separately photographed images are combined with each other and output by using the application installed on the smart device 10.

To achieve this, as shown in FIG. 12, the camera unit 30-1 requires the mount 20 that matches up an optical axis of the smart device 10 with an optical axis of the camera lens 100.

Further, as shown in FIG. 9, the present invention may include content that allows sharing information on a radioactive substance obtained by the application (not shown) by sending the obtained information to the server 500, whereby information on radiation is formed into an information cloud, thus enabling information to be shared with a user that accesses the server 500.

For example, information that is sent to the server 500 may be provided by marking the information on a map.

A location, a picture, a text, and numerical information about a subject are viewed on the map, whereby the information on radiation can be shared widely, and also the server 500 allows the information to be utilized as information on a degree of local radioactive contamination, by collecting and processing the information.

Meanwhile, the image intensifier tube 340 requires power for amplifying light. Thus, as shown in FIG. 4, the mount 20 may include a battery casing having a battery 400 for supplying power to the light amplification tube 340.

Further, the mount 20 may include a connecting terminal 210 that is connected to the smart device 10 so as to inform the smart device 10 about a state of operational readiness of the apparatus by simply mounting a mount 20 to the smart device 10.

FIG. 3 is a view showing a smart device casing that is provided with the connecting terminal 210, wherein the application is automatically operated by the connecting terminal 210, thereby allowing radioactive image information to be obtained.

As described above, although reference to the embodiments has allowed the present invention to be described in more detail, it should be understood that the present invention is not limited to the embodiments but may be variously changed without departing from the technical idea of the present invention.

Therefore, the embodiments disclosed in the present invention are not restrictive but are illustrative, and the scope of the technical idea of the present invention is not limited to the embodiments. The scope of the present invention should be interpreted by the accompanying claims, and it is to be understood that all technical ideas within the claims fall within the purview of the present invention.

1. An apparatus for photographing a radioactive substance by using a smart device, the apparatus comprising:
a radioactive information collection unit including a camera barrel, a dark curtain as a visible light blocking filter provided at an object-side extremity of the camera barrel, and an intensifying layer being sensitive to radioactive rays and generating visible light by being provided on a rear surface of the dark curtain;
a smart device;
a mount coupled to the radioactive information collection unit by being mounted at an eye-side extremity of the camera barrel such that an optical axis of a camera lens of the smart device matches up with an optical axis of the camera barrel; and
an application provided in the smart device for calculational processing and output of image information produced via the radioactive information collection unit, wherein
the apparatus is capable of outputting a radioactive substance included in a subject, as a radioactive picture, an image, or text by using the smart device.

2. The apparatus of claim 1, wherein the radioactive information collection unit is provided with an image intensifier tube on a rear surface of the intensifying layer for amplifying a photoreaction of the intensifying layer, thereby amplifying reactive visible light.

3. The apparatus of claim 2, wherein the radioactive information collection unit further includes a light collector provided on the rear surface of the intensifying layer.

4. The apparatus of claim 3, wherein the intensifying layer is provided in a form of an intensifying screen that causes a visible light reaction to radioactivity.

5. The apparatus of claim 4, wherein the camera barrel is configured such that
an end thereof is bent to be reverse L-shaped;
a communicating hole for visible light is provided at a lower portion of the end being bent, the communicating hole corresponding to an optical axis of a camera of the smart device; and
a prism provided at the end being bent matches up an optical axis of an image coming into the communicating hole for visible light with an optical axis of an output image of the radioactive information collection unit, combines the image coming into the communicating hole and the output image of the radioactive information collection unit together, and sends the combined image to the camera of the smart device, whereby
the apparatus is capable of outputting an image of the camera of the smart device, along with information on radiation.

6. The apparatus of claim 5, wherein the mount includes:
a battery casing having a battery for supplying power to the image intensifier tube;
and a connecting terminal for inputting and outputting a command signal for controlling the battery by being connected to the smart device.

7. The apparatus of claim 6, wherein the mount is provided in a form of a smart device casing so as to serve as a camera for photographing a radioactive substance when being mounted to the smart device.

8. An apparatus for photographing a radioactive substance by using a smart device, the apparatus comprising:
a camera unit configured such that a light collector, an image intensifier tube and an image pickup device are sequentially coupled to a camera barrel, and a radioactive information collection unit including a dark curtain and an intensifying layer is coupled to a front end or a rear end of the light collector so that the radioactive information collection unit blocks visible light, and generates visible light by being sensitive to radioactive rays, thereby outputting radioactive image information;
a smart device;
a wire or wireless interface for interfacing the camera unit with the smart device; and
an application provided in the smart device for calculational processing and output of image information produced via the radioactive information collection unit, wherein
the apparatus is capable of outputting a radioactive substance included in a subject, as a radioactive picture, an image or text by using the smart device.

9. The apparatus of claim 8, further comprising
a mount for coupling the camera unit and the smart device such that an optical axis of the camera unit matches up with an optical axis of a camera lens of the smart device.

10. The apparatus of claim 1, wherein the application includes content for controlling camera shutter speed used to photograph optical information on radiation.

11. The apparatus of claim 8, wherein the application includes content for controlling camera shutter speed used to photograph optical information on radiation.
